(19) United States
(12) Patent Application Publication
(10) Pub. No.: US 2006/0026692 A1
(43) Pub. Date: Feb. 2, 2006

(54) Network resource access authentication apparatus and method

(76) Inventor: Imran Y. Lakhani, Lehi, UT (US)

Correspondence Address: PATE PIERCE & BAIRD, 215 SOUTH STATE STREET, SUITE 550, PARKSIDE TOWER, SALT LAKE CITY, UT, 84111, US

(21) Appl. No.: 11/191,844

(22) Filed: Jul. 28, 2005

Related U.S. Application Data
(60) Provisional application No. 60/592,368, filed on Jul. 29, 2004.

(51) Int. Cl. H04L 9/32; G06K 9/00; G06F 17/30; G06F 7/04; G06F 15/16; H03M 1/68; G06F 7/58; H04K 1/00; G06K 19/00; H04L 9/00; H04N 7/16

(52) U.S. Cl. 726/28; 726/4

(57) ABSTRACT

An apparatus and method for controlling access to network resources. The method may include providing an application server and content server operably connected to a network. The application server may receive a user request from a user computer and respond thereto by transmitting selected data. Later, the content server may receive from the user computer a content request comprising at least some portion of the selected data, generate an authentication request, and transmit the authentication request to the application server. The application server may then receive the authentication request, make a determination whether the content request is valid, generate the authentication response in accordance with the determination, and transmit an authentication response to the content server. Finally, the content server may serve or deny content to or from the user computer in accordance with the authentication response received from the application server.

### RELATED APPLICATIONS

This application claims the benefit of co-pending U.S. Provisional Patent Application Ser. No. 60/592,368, filed on Jul. 29, 2004 for AUTHENTICATION OF INDIVIDUAL USERS TO INTERACTIVE MULTIMEDIA CONTENT.

### BACKGROUND

1. The Field of the Invention

This invention relates to computerized authentication systems and, more particularly, to novel systems and methods for controlling access to content over a network.

2. The Background Art

The Internet is a pervasive system of computers interconnected over communications lines. Commerce has become E-commerce conducted over the Internet for many purposes, products, businesses, and customers. Likewise, web logs (blogs), commercial endeavors, political organizations, educational structures and organizations, and the like all post information on websites accessible over the Internet. Auctions, commercial establishments, conventional sales and distribution organizations, individuals, newspapers and other advertising media, and the like all provide access to information over the Internet.

Additionally, individuals have been able to send digital information, either as text, images, or streaming video, and the like over the Internet by e-mail and other mechanisms. Likewise, individual websites may publish virtually any information in any of the foregoing formats for digital information.

However, current systems providing the ability to download, post, edit, remove, etc. information over the Internet are fundamentally insecure. For example, systems providing some mechanism for control over access to information or the ability to change information on a website have historically been inadequately secured. Thus, through accident or intention, hackers, customers, clients, competitors, and agents may all change, improperly download, or otherwise obtain informational content posted on a website.

For example, currently, multimedia content and applications are readily available over the Internet. Multimedia content and applications enable greater interactivity in an online experience. Typically, however, multimedia content and applications are deployed with no security measures in place. Accordingly, typically no cost-effective, ready, universal, mechanism exists for ensuring the identity of users viewing or modifying the content of typical websites.

What is needed is a system for posting information (e.g., applications, content, or the like), whereby an automated server can pass, with the information, required access control information in the form of tokens, security files, applications, data files, or the like to verify and authenticate the identities of persons or computers accessing, posting, downloading, and editing the information.

### BRIEF SUMMARY OF THE INVENTION

In view of the foregoing, in accordance with the invention as embodied and broadly described herein, a method and apparatus are disclosed in one embodiment of the present invention as including a system and method for authentication, enabling users to gain access to content stored on a network. In selected embodiments, an authentication system may include at least one user computer, at least one application server, and at least one content server. Any suitable network may be used to connect a user computer, application server, and content server. For example, in selected embodiments, the user computer, application server, and content server may be connected via the Internet.

Multiple scenarios are available when deploying an authentication system in accordance with the present invention. For example, in selected embodiments, an application server and a content server may reside on separate physical systems. Conversely it is also possible that the application server and the content server reside within the same physical system. In such a case, all communication may take place in modules developed to facilitate the specific functions otherwise performed by the individual application and content servers.

The processes of an authentication system in accordance with the present invention may begin when a user request from the user computer is received by the application server. The application server may respond to the user request by transmitting an object to the user computer. In certain embodiments, the object may identify the content desired by the user and include the application required for the user to effectively utilize that content. Additionally, the object may include a token, limiting in some manner the user's rights in the desired content. In selected embodiments, the desired content may include “multimedia” content such as pictures, audio, video, text, or any other content generated for the purpose of interactive presentation.

Using the data provided in the object, the user computer may generate a content request and transmit the same to the content server. In certain embodiments, a content request may include a request by the user computer that it be served with the content desired by the user. The content request may also include the token provided by the application server to the user computer.

Using the data provided in the content request, the content server may generate an authentication request and transmit the same to the application server. In selected embodiments, the authentication request may include the token provided by the user computer to the content server.

After receiving and analyzing the authentication request, and token therein, the application server may determine whether the user computer has a legitimate right to the desired content. An authentication response communicating this determination may be generated and transmitted to the content server. Accordingly, using the authentication response as its guide, the content server may prepare a response to the content request. The response may comprise either a service or denial of the desired content. In this manner, the application server, who was the first to interact with the user computer, may have the last word on whether the desired content is served or denied.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a schematic, block diagram illustrating a computer system for implementing an authentication system in accordance with the present invention;

FIG. 2 is a schematic, block diagram providing a high-level overview of one embodiment of an authentication system in accordance with the present invention;

FIG. 3 is a schematic, block diagram illustrating one embodiment of an application server in accordance with the present invention;

FIG. 4 is a block diagram illustrating the application delivery process performed by an application server in accordance with the present invention;

FIG. 5 is a block diagram illustrating the authentication process performed by an application server in accordance with the present invention;

FIG. 6 is a schematic, block diagram illustrating one embodiment of an object passed from an application server to a user computer in accordance with the present invention;

FIG. 7 is a schematic, block diagram illustrating one embodiment of a user computer in accordance with the present invention;

FIG. 8 is a block diagram illustrating one embodiment of a content procurement process performed by a user computer in accordance with the present invention;

FIG. 9 is a schematic, block diagram illustrating one embodiment of a content server in accordance with the present invention;

FIG. 10 is a block diagram illustrating one embodiment of a content verification and delivery process performed by a content server in accordance with the present invention; and

FIG. 11 is a schematic, block diagram providing a high-level overview of an alternative embodiment of an authentication system in accordance with the present invention.

### DETAILED DESCRIPTION OF THE PREFERRED EMBODIMENTS

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, as claimed, but is merely representative of various embodiments of the invention. The illustrated embodiments of the invention will be best understood by reference to the drawings, wherein like parts are designated by like numerals throughout.

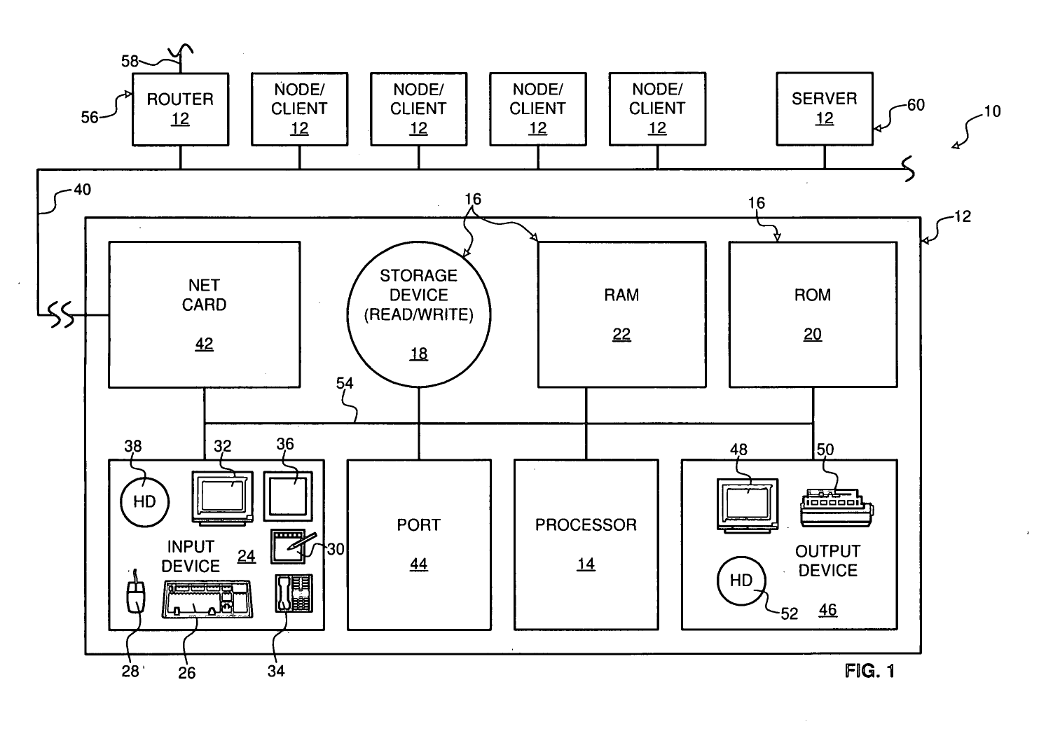

Referring to FIG. 1, an computer apparatus 10 or computer system 10 for implementing the present invention may include one or more nodes 12 (e.g., client 12, computer 12). Such nodes 12 may contain a processor 14 or CPU 14. The CPU 14 may be operably connected to a memory device 16. A memory device 16 may include one or more devices such as a hard drive 18 or other non-volatile storage device 18, a read-only memory 20 (ROM 20), and a random access (and usually volatile) memory 22 (RAM 22 or operational memory 22). Such components 14, 16, 18, 20, 22 may exist in a single node 12 or may exist in multiple nodes 12 remote from one another.

In selected embodiments, the apparatus 10 may include an input device 24 for receiving inputs from a user or from another device. Input devices 24 may include one or more physical embodiments. For example, a keyboard 26 may be used for interaction with the user, as may a mouse 28 or stylus pad 30. A touch screen 32, a telephone 34, or simply a telecommunications line 34, may be used for communication with other devices, with a user, or the like. Similarly, a scanner 36 may be used to receive graphical inputs, which may or may not be translated to other formats. A hard drive 38 or other memory device 38 may be used as an input device whether resident within the particular node 12 or some other node 12 connected by a network 40. In selected embodiments, a network card 42 (interface card 42) or port 44 may be provided within a node 12 to facilitate communication through such a network 40.

In certain embodiments, an output device 46 may be provided within a node 12, or accessible within the apparatus 10. Output devices 46 may include one or more physical hardware units. For example, in general, a port 44 may be used to accept inputs into and send outputs from the node 12. Nevertheless, a monitor 48 may provide outputs to a user for feedback during a process, or for assisting two-way communication between the processor 14 and a user. A printer 50, a hard drive 52, or other device may be used for outputting information as output devices 46.

Internally, a bus 54, or plurality of buses 54, may operably interconnect the processor 14, memory devices 16, input devices 24, output devices 46, network card 42, and port 44. The bus 54 may be thought of as a data carrier. As such, the bus 54 may be embodied in numerous configurations. Wire, fiber optic line, wireless electromagnetic communications by visible light, infrared, and radio frequencies may likewise be implemented as appropriate for the bus 54 and the network 40.

In general, a network 40 to which a node 12 connects may, in turn, be connected through a router 56 to another network 58. In general, nodes 12 may be on the same network 40, adjoining networks (i.e., network 40 and neighboring network 58), or may be separated by multiple routers 56 and multiple networks as individual nodes 12 on an internetwork. The individual nodes 12 may have various communication capabilities. In certain embodiments, a minimum of logical capability may be available in any node 12. For example, each node 12 may contain a processor 12 with more or less of the other components described hereinabove.

A network 40 may include one or more servers 60. Servers 60 may be used to manage, store, communicate, transfer, access, update, and the like, any practical number of files, databases, or the like for other nodes 12 on a network 40. Typically, a server 60 may be accessed by all nodes 12 on a network 40. Nevertheless, other special functions, including communications, applications, directory services, and the like, may be implemented by an individual server 60 or multiple servers 60.

In general, a node 12 may need to communicate over a network 40 with a server 60, a router 56, or other nodes 12. Similarly, a node 12 may need to communicate over another neighboring network 58 in an internetwork connection with some remote node 12. Likewise, individual components may need to communicate data with one another. A communication link may exist, in general, between any pair of devices.

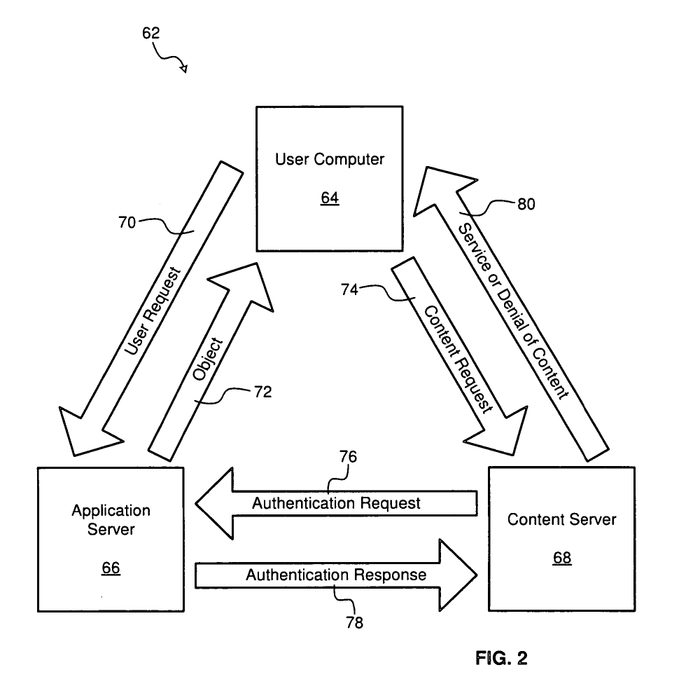

Referring to FIG. 2, a computer system 10 may support an authentication system 62 in accordance with the present invention. In selected embodiments, an authentication system 62 may include at least one user computer 64, at least one application server 66, and at least one content server 68. In general, a user computer 64 may be any node 12 operably connected via a network 40 or neighboring network 58 to the application server 66 and the content server 68. Similarly, the application server 66 and content server 68 may be hosted on any node 12 or combination of nodes 12 operably connected via the network 40 or neighboring network 58 to each other as well as to the user computer 64.

Any suitable network 40 or neighboring network 58 may be used to connect the user computer 64, application server 66, and content server 68. For example, in selected embodiments, the user computer 64, application server 66, and content server 68 may be connected via a local area network (LAN). Alternatively, the user computer 64, application server 66, and content server 68 may be connected via the Internet. In still other embodiments, the user computer 64, application server 66, and content server 68 may be connected by some combination of a local area network and the Internet.

The processes of the authentication system 62 in accordance with the present invention may begin when a user request 70 from the user computer 64 is received by the application server 66. To the user whose inputs initiated the user request 70, the user request 70 may be viewed as a request for content (e.g., one or more resources) such as musical compositions, motion pictures, text, software, or the like. However, the user request 70 may actually comprise a request for an application (i.e., a full application, applet, or the like) allowing the user to present or otherwise utilize desired content stored within the content server 68.

The application server 66 may respond to the user request 70 by transmitting an object 72 to the user computer 64. In certain embodiments, the object 72 may identify the content desired by the user and include the application required for the user to effectively utilize that content. Additionally, the object 72 may include a token, limiting in some manner the user's rights in the desired content.

In selected embodiments, an object 72 in accordance with the present invention may be transmitted to the user computer 64 without an application. For example, in some situations, a user computer 64 may have previously downloaded the required application. For example, the user may be a repeat customer seeking only new content. Accordingly, by determining that the user computer 64 already has the appropriate application, the application server 66 may simply prepare an object 72 including an identification of the desired content and a token granting the user computer an authorization to access that content.

In general, a token may be included within an object 72 corresponding to “private” content stored with the content server 68. In selected embodiments, where the object 72 corresponds to “public” content stored with the content server 68, a token may be omitted form the object. Accordingly, an object 72 having no token or an “anonymous” token may be an indication that the desired content is of a public or otherwise unrestricted nature.

Using the data provided in the object 72, the user computer 64 may generate a content request 74 and transmit the same to the content server 68. In certain embodiments, a content request 74 may include a request by the user computer 64 that it be served with the content desired by the user. The content request 74 may also include the token provided by the application server 66 to the user computer 64.

In selected embodiments, the generation and transmission of a content request 74 may be substantially transparent to the user of the user computer 64. That is, the user may or may not be informed that the user computer 64 has contacted a different server (i.e., the content server 68, as opposed to the original application server 66).

Using the data provided in the content request 74, the content server 68 may generate an authentication request 76 and transmit the same to the application server 66. In selected embodiments, the authentication request 76 may include the token provided by the user computer 64 to the content server 68. One valuable purpose of the token may be enablement of the application server 66 to verify integrity of the token.

After receiving and analyzing the authentication request 76, the application server 66 may determine whether the user computer 64 has a legitimate right to the desired content. An authentication response 78 communicating this determination may be generated and transmitted to the content server 68. Accordingly, using the authentication response 78 as its guide, the content server 68 may prepare a response 80 to the content request 74. That is, the content server 68 may prepare a response 80 either serving or denying the desired content. In this manner, the entity (i.e., the application server 66) who first interacted with the user computer 64 may have the last word on whether the content is served or denied.

Appropriate checks may be implemented as needed to ensure that communications (e.g., authentications requests 76, authentication response 78, and the like) passing between the application server 66 and content server 68 are indeed originating from the appropriate trusted source.

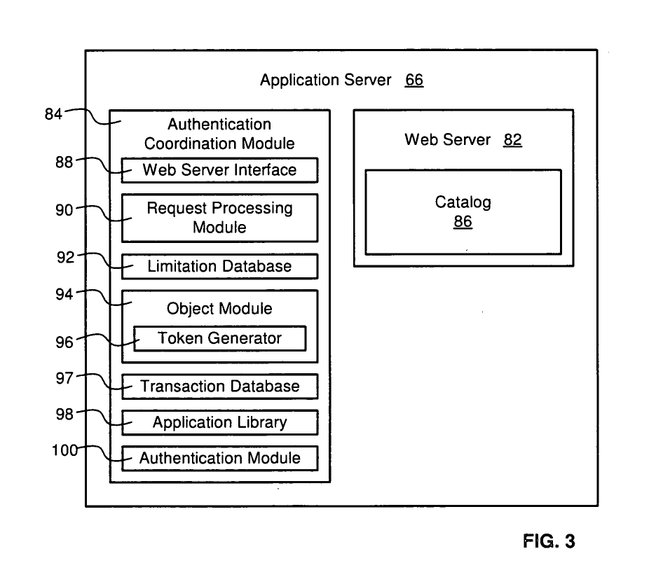

Referring to FIG. 3, an application server 66 in accordance with the present invention may comprise any software, hardware, or software and hardware configuration capable of receiving user requests 70 and returning appropriate objects 72 and receiving authentication requests 76 and returning appropriate responses 78. However, in general, the configuration of an application server 66 may conform to characteristics or requirements of the network 40, 58 over which it operates.

In selected embodiments, an application server 66 may operate over the Internet. Accordingly, if desired or necessary, an application server 66 may include a web server 82. For example, an application server 66 in accordance with the present invention may include web server 82 such as Apache, Microsoft's Internet Information Server (IIS), or the like coupled to an authentication coordination module 84. If desired, the authentication coordination module 84 may be configured as a plug-in to the web server 82. Alternatively, an application server 66 may incorporate the functionality provided by both a web server 82 and an authentication coordination module 84 within an independent and integral software package.

In selected embodiments, an application server 66 may include (e.g., store and serve) a catalog 86 identifying content stored within the content server 68. The catalog 86 may be presented or made accessible to user of the user computer 64 in any suitable manner. In general, it may be advantageous to present the catalog 86 in a manner facilitating or supporting navigation therethrough. Accordingly, in certain embodiments, the catalog 86 may be hosted on the Internet by the web server 82. Thus, through an Internet browser, a user of the user computer 64 may search the catalog 86 and identify desired content. The user may then provide inputs (e.g., mouse clicks, text entries) to the user computer 64 instructing the Internet browser to generate a corresponding user request 70.

Upon receipt of a user request 70 relating to content identified within the catalog 86, the application server 66 may direct the user request 70 to the authentication coordination module 84. For example, while searching the catalog 86, a user computer 64 may be primarily interacting with the web server 82. Accordingly, when the web server 82 receives a user request 70 relating to content identified within the catalog 86, the web server 82 may direct the user request 70 to the authentication coordination module 84 for further processing.

An authentication coordination module 84 may include a web server interface 88. As necessary or desired, the web server interface 88 may manage, translate, and direct communications between the authentication coordination module 84 and the web server 82. In certain embodiments, the web server interface 88 may include an application programming interface (API) defining the ways in which the authentication coordination module 84 may communicate with the web server 82.

An authentication coordination module 84 in accordance with the present invention may also include a request processing module 90. The request processing module 90 may examine a user request 70 and extract or derive the information needed to prepare a proper object 72 in response thereto. For example, in selected embodiments, the request processing module 90 may receive a user request 70 and extract the identity of the user initiating the request 70, the identify of the user computer 64 sending the request 70, the content desired by the user, the type of application required to present or utilize the content, the user-imposed limitations associated with the request 70, the server-imposed limitations associated with the desired content, or the like.

User-imposed limitations may include any option, choice, or selection made by the user. For example, when entering the inputs necessary to generate a user request 70, a user may indicate that he or she only wishes to download a motion picture for a single viewing. Accordingly, by learning that the user only desires a single viewing (and perhaps only purchased a single viewing), the request processing module 90 may ensure that any response (e.g., object 72) given to the user computer 64 will limit the user computer 64 to the agreed upon single viewing.

In addition to limitations on the number of times a resource may be presented or utilized, other user-imposed limitations may include limitations on the time period in which a resource may be presented, the digital quality of a resource, the time of day when the resource is to be downloaded, the bandwidth allocated to the resource, or the like.

Server-imposed limitations may include any limitation that is outside the discretion of the user initiating the user request 70. For example, a server-imposed limitation may require that a resource be downloaded, presented, or downloaded and presented within a selected period of time. Other suitable server-imposed limitations may include limitations on the number of times particular content may be presented or used, the digital quality of particular content, the time of day when particular content is to be downloaded, the bandwidth allocated to particular content, the users who may access particular content (controlled by user password, user social security number, user email address, or the like), the user computers 64 that may access particular content (controlled by hardware address or the like), the number of users, the type of encryption imposed, or the like.

In certain embodiments, an authentication coordination module 84 may include a limitation database 92. Within the limitation database 92, the server-imposed limitations applicable to the content listed within the catalog 86 may be stored, organized, and maintained. In selected embodiments, the request processing module 90 may query the limitation database 92 to determine which server-imposed limitations are applicable to the content identified within the user request 70.

Other server-imposed limitations may be generated during the transaction between the user computer 64 and the application server 66. For example, a user computer 64 having a particular hardware address may send a user request 70 identifying a particular resource. The application server 66 (e.g., request processing module 90) may generate a server-imposed limitation ensuring that the particular content is only served to a user computer 64 having that particular hardware address. In selected embodiments, such server-imposed limitations may be encoded within the token. Accordingly, a content request 74 originating from a different hardware address may be recognized as such, and the desired content may be denied.

For some content listed within the catalog 86, the server-imposed limitations stored within the limitation database 92 may be minimal or even non-existent. For other content, the corresponding server-imposed limitations may be extensive. For still other content, the corresponding server-imposed limitations may neither be minimal nor extensive, but rather somewhere in between. Accordingly, the granularity (e.g. scope, focus, etc.) of the server-imposed limitations stored within the limitation database 92 or generated during a transaction may be controlled on a content-by-content (e.g. resource-by-resource) basis.

In certain embodiments, an authentication coordination module 84 may include an object module 94. Once the request processing module 90 has gathered all the information necessary to prepare a proper response to the user request 70, the object module 94 may compile the information into a suitable form (e.g., an object 72) and pass the same through the web server interface 88 to the application server 66, where it may be transmitted to the user computer 64. Accordingly, the object module 94 may be primarily responsible for populating the object 72.

In selected embodiments, an object module 94 may include a token generator 96. The token generator 96 may be primarily responsible for creating and encoding the token. In general, a token in accordance with the present invention may comprise any suitable collection of alphanumeric characters. In selected embodiments, a token may contain encoded information. For example, the identify of the one or more resources desired, the user-imposed limitations, and the server-imposed limitations may all be encoded within the token. In other embodiments, a token may simply act as a key, without which, the content server will not serve, and the application will not present, the one or more resources desired.

In certain embodiments, an authentication coordination module 84 may include a transaction database 97. A transaction database 97 may store, organize, and manage information relating the various transactions between an application server 66 and the various user computers 64 sending user requests 70 thereto. For example, a transaction database 97 may store information for each user request 70 (e.g., user identification, user computer identification, content requested, user-imposed limitations, and the like) and the corresponding responsive object 72 (e.g., application sent, content identification, token sent, server-imposed limitations, and the like). Accordingly, when an application server 66 receives an authentication request 76 from a content server 68, it may already have a variety of records against which the information extracted from the corresponding content request 74 may be evaluated or compared.

In selected embodiments, an authentication coordination module 84 may include an application library 98. An application library 98 may comprise a collection of the various applications necessary to present or utilize the content stored within the content server 68. Once informed by the request processing module 90 of the type of application necessary to display the desired content, the object module 94 may select the appropriate application from the application library 98 and include the same within the object 72 passed on to the user computer 64.

In certain embodiments, an authentication coordination module 84 may include an authentication module 100. An authentication module 100 may be primarily responsible for receiving and analyzing the authentication request 76. By comparing information stored within the transaction database 97 with that provided in the authentication request, the authentication module 100 may determine whether the user computer 64 has a legitimate right to the content identified within the content request 74. The authentication module 100 may then generate and transmit an authentication response 78 communicating the results of this determination to the content server 68.

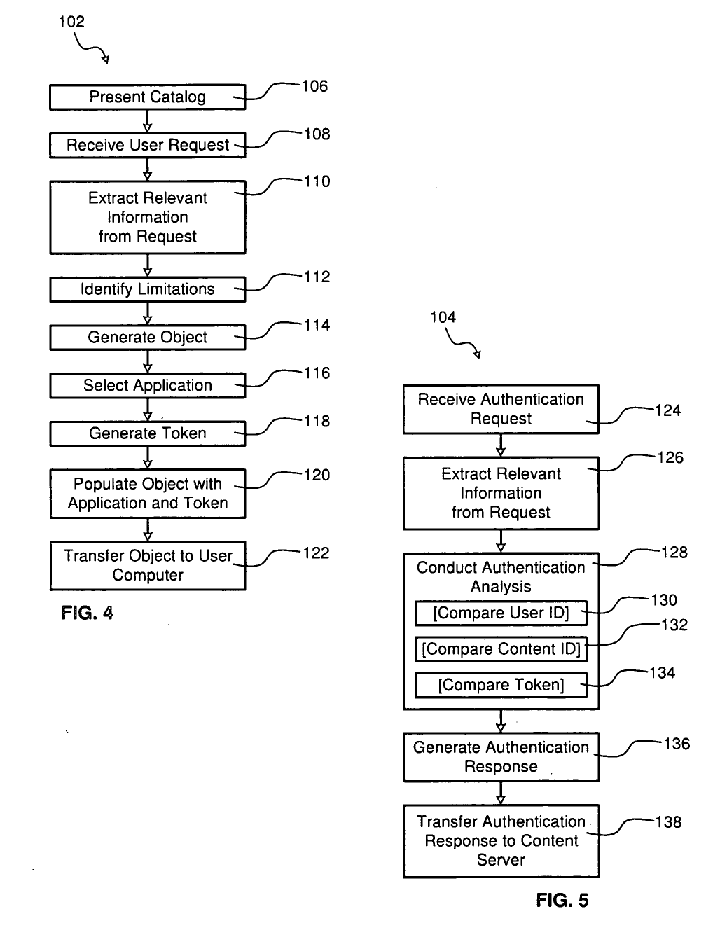

Referring to FIG. 4, the foregoing provides one or more possible embodiments, architectures, or structural arrangements for an application server 66 in accordance with the present invention. These embodiments are to be considered in all respects only as illustrative, and not restrictive.

In general, the interaction of an application server 66 with a user computer 64 may be referred to as an application delivery process 102. The interaction of an application server 66 with a content server 68 may be referred to as an authentication process 104. Any software, hardware, or software and hardware configuration capable of performing the application delivery process 102 and the authentication process 104 may be considered an application server 66 in accordance with the present invention.

In selected embodiments, an application delivery process 102 may begin when the application server 66 presents 106 the catalog 86 in an manner rendering it accessible to one or more users through one or more corresponding user computers 64. Accordingly, through an appropriate user computer 64, the application server 66 may receive 108 a user request 70.

The application server 66 may extract 110 the relevant information contained within the user request 70. From this information, the application server 66 may identify 112 which limitations (e.g., user-imposed limitations, server-imposed limitations, or the like) are to be imposed on the content identified within the user request 70.

The application delivery process 102 may continue with the generation 114 of an object 72 acting as the communication vehicle between the application server 66 and the user computer 64. An appropriate application may be selected 116 according to the nature of the content desired by the user. An appropriate token may be generated 118 to reflect or communicate the limitations previously identified 112. In selected embodiments, if no limitations are to be imposed, the token need not be generated and may be omitted. The application server 66 may then populate 120 the object 72 with the selected application, applications, appropriate token, or other operational data as necessary or desired. This populated object 72 may then be transferred 122 to the user computer 64.

In certain embodiments, an application delivery process 102 may proceed in an order different from that illustrated in FIG. 4. For example, in selected embodiments, the object 72 may be generated 114 after the application is selected 116 and the token is generated 118.

Referring to FIG. 5, in selected embodiments, an authentication process 104 may begin when an application server 66 receives 124 an authentication request 76 from an appropriate content server 68. The application server 66 may then extract 126 the relevant information contained within the authentication request 76 and conduct an authentication analysis 128 on all or selected portions thereof.

The nature of the authentication analysis 128 may vary widely according to the nature of the authentication request 76, the token contained within the request 76, or the like. In certain embodiments, an authentication analysis 128 may include a comparison 130 of the user identification (e.g., personal user identification, user computer identification, or the like) contained within the authentication request 76 and the user identification contained within the original user request 70. Similarly, an authentication analysis 128 may include a comparison 132 of the content indicated in the authentication request 76 and the content indicated in the original user request 70. Additionally, an authentication analysis 128 may include a comparison 134 of the token contained within the authentication request 76 and the token generated in response to the original user request 70.

If no token, or an anonymous token, is provided in the authentication request 76, the application server 66 may simply verify that the desired content is indeed public and subject to no additional access limitations. In selected embodiments, however, even with public content, certain bookkeeping or administrative limitations may be imposed. For example, the application server 66 may verify that the user computer 64 making the content request 64 is the same one that sent the original user request 70.

In accordance with the findings of the authentication analysis 128, an application server 66 may generate 136 an authentication response 78. For example, if the authentication analysis 128 reveals an inconsistency between the user identification provided in the user request 70 and the user identification provided in the authentication request 76, the application server 66 may generate 136 an authentication response 78 instructing the content server 68 to deny content. Similarly, if the authentication analysis 128 reveals that the content request 74 violates a particular limitation (e.g., user-imposed limitation, server-imposed limitation, or the like), the application server 66 may generate 136 an authentication response 78 instructing the content server 68 to deny content.

However, if the authentication analysis 128 reveals no inconsistencies or violations, the application server 66 may generate 136 an authentication response 78 instructing the content server 68 to serve the desired content. The authentication process 104 may conclude when the authentication response 78 previously generated 136 is transferred 138 to the content server 68.

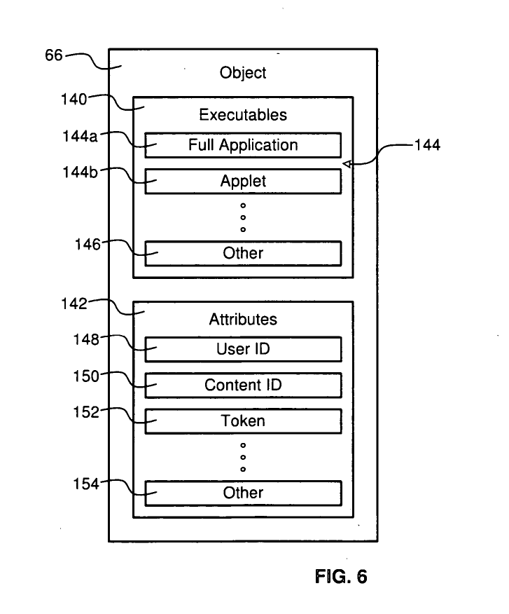

Referring to FIG. 6, an object 72 in accordance with the present invention may include executables 140 and attributes 142. In selected embodiments, the executables 140 may provide the methods or instructions, while the attributes 142 provide at least some of the operational data to be manipulated in accordance therewith. For example, the executables 140 may include one or more applications 144 (e.g., full applications 144a, applets 144b) or some other 146 executable data. The attributes 142 may include one or more user identifications 148, one or more content (resource) identifications 150, one or more tokens 152, or some other 154 operational data.

An application 144 may be defined as a software program allowing a user to perform one or more specific tasks. Applications 144 in accordance with the invention may allow a user to present or otherwise utilize content stored within the content server 68. A full application 144a may be defined as an application 144 capable of independent operation. That is, using only an operating system and the associated system utilities, a full application 144a may perform its intended function.

An applet 144b is a different kind of application 144. In general, an applet 144b is a small executable module lacking the complete features and user interface commonly found in a full application 144a. Accordingly, an applet 144b typically needs a full application 144a to contain it. For example, an applet 144b may operate within an Internet browsing application 144a to allow a user to listen to a musical composition, view a motion picture, or the like.

The functionality of an application 144 may vary according to the nature of the content presented or utilized thereby. For example, one application 144 may allow a user to listen to a musical composition. Another application 144 may allow a user to view a motion picture. Yet another application 144 may allow a user to read, view, or print a textual document.

In selected embodiments, one or more applications 144 may be configured to decode content delivered in an encoded format. Accordingly, such content may only be utilized in combination with corresponding applications 144. In certain embodiments, an application may be token dependent. For example, the application may only execute or “turn on” when provide a valid token, which, in some embodiments, it may periodically verify through the content server 68. Alternatively, or in addition, an application may be scrambled unless provided a valid token. Thus, an authentication system 62 in accordance with the present invention may control the service of content as well as the utilization of that content thereafter.

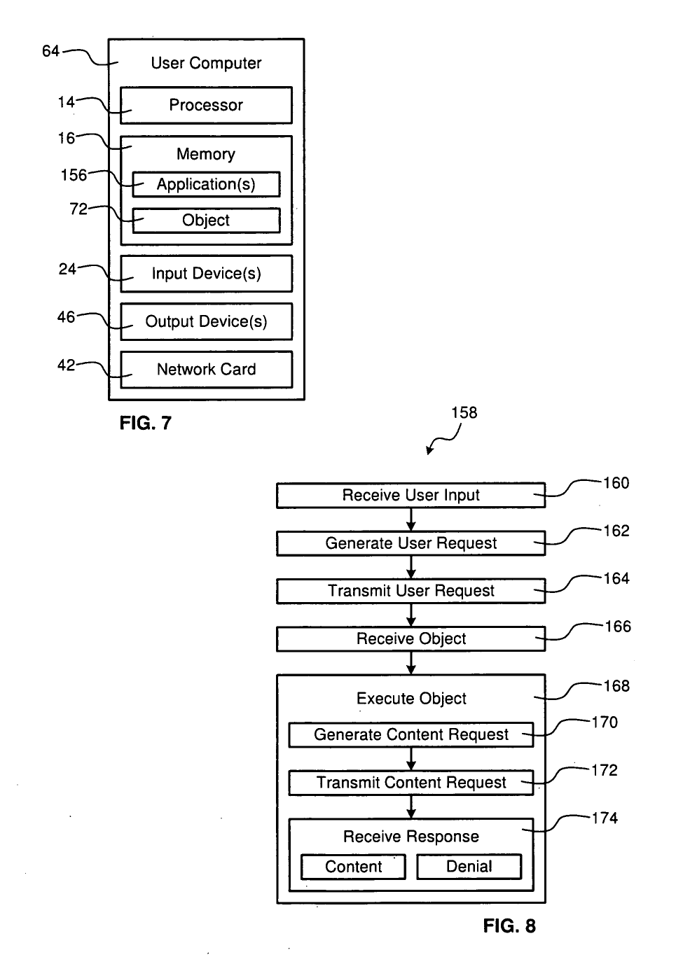

Referring to FIG. 7, in certain embodiments, a user computer 64 may include a processor 14, memory 16, one or more input devices 24, one or more output devices 46, and a network card 42. The memory 16 may store one or more applications 156 as desired or necessary. In some embodiments, the memory 16 may store an application 156 permitting the user computer 64 to interact with the application server 66. For example, in one embodiment, the memory 16 may store an Internet browser 156. Additionally, once it is provided by the application server 66, an object 72 may also be stored within the memory 16 of the user computer 64.

In general, the interaction of a user computer 64 with an application server 66 and a content server 68 may be referred to as a content procurement process 158. Any software, hardware, or software and hardware configuration capable of performing the content procurement process 158 may be considered a user computer 64 in accordance with the present invention.

Referring to FIG. 8, in selected embodiments, the content procurement process 158 may begin when the user computer 64 receives 160 one or more user inputs. These inputs may comprise instructions to open an Internet browser 156, access an application server 66, browse a catalog 86, and select certain content listed in the catalog 86. From these inputs, a user computer 64 may generate 162 a user request 70. The user request 70 may then be transmitted 164 to the application server 66.

In response to the user request 70, a user computer 64 may receive 166 an object 72. The object 72 may be executed 168 as desired or necessary. For example, an application 144 contained with the object 72 may be stored in memory 16 where it may be retrieved and run by the processor 14. In selected embodiments, execution 168 of an object 72 may cause the generation 170 of a content request 74, which may subsequently be transmitted 172 to the content server 66.

Eventually, the user computer 64 may receive 174 a response 80 to the content request 74. In general, this response 80 may take one of two forms. In one form, the response 80 may comprise a service of content. In the alternative form, the response 80 may comprise a denial of content. In selected embodiments, a response 80 corresponding to a denial of content may comprise no response. That is, providing no response to a content request 74 may be considered a response 80 indicating a denial of content and may be so interpreted by the user computer 64. If the response 80 comprises a service of content, additional inputs provided by the user to the user computer 64 may determine how and when the content is to be presented or otherwise utilized by the application 144.

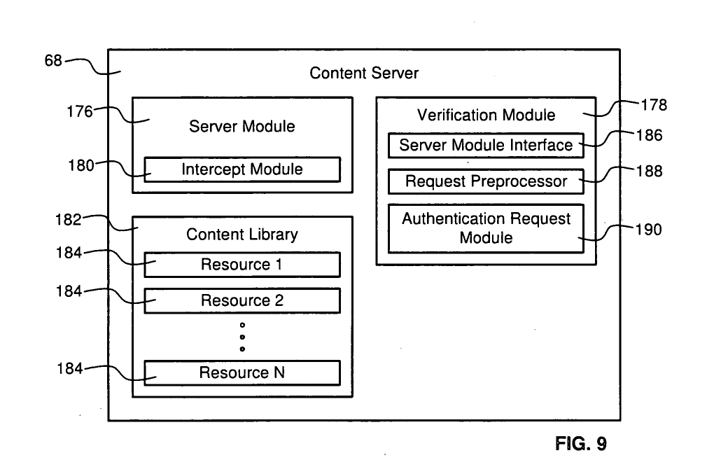

Referring to FIG. 9, a content server 68 in accordance with the present invention may comprise any software, hardware, or software and hardware configuration capable of receiving content requests 74, generating and transmitting authentication requests 76, receiving authentication responses 78, and serving 80 or denying 80 content based on the authentication responses 78. However, in general, the configuration of a content server 68 may conform to characteristics or requirements of the network 40, 58 over which it operates.

In selected embodiments, a content server 68 may operate over the Internet. Accordingly, if desired or necessary, a content server 68 may include a server module 176 configured to deliver content over the Internet. For example, a content server 68 in accordance with the present invention may include server module 176 such as a Macromedia flash server or the like coupled to a verification module 178. If desired, the verification module 178 may be configured as a plug-in to the server module 176. Alternatively, a content server 68 may incorporate the functionality provided by both a server 176 and a verification module 178 within an independent and integral software package.

In certain situations, without other provisions, a typical server module 176 may immediately server up content in response to content requests 74. Accordingly, in selected embodiments, a content server 68 in accordance with the present invention may include an intercept module 180. An intercept module 180 may be configured to divert content requests 74 to the verification module 178 before any attempt is made to serve the content requested. In certain embodiments, the intercept module 180 may be included as part of the server module 176.

In selected embodiments, a content server 68 may include a content library 182. A content library 182 may store, organize, and maintain content. In certain embodiments, individualized content may be referred to as a resource 184. One resource 184 may comprise a musical composition. Another resource 184 may comprise a motion picture. Yet another resource 184 may comprise a text document. Still other resources 184 may comprises other formats or compositions. Accordingly, a content library 182 may include one or more resources 184 representing various types of content.

Upon receipt of a content request 74, the intercept module 180 may direct the content request 74 to the verification module 178. Accordingly, in selected embodiments, a verification module 178 may include a server module interface 186. As necessary or desired, the server module interface 186 may manage, translate, and direct communications between the server module 176 and the verification module 178.

In certain embodiments, a verification module 178 in accordance with the present invention may also include a request preprocessor 188. A request preprocessor 188 may conduct a coarse or initial analysis regarding the validity of the content request 74. While the request preprocessor 188 may not conduct a detailed analysis like the authentication module 100 of the application server 66, the request preprocessor may screen content requests 74 in an effort to locate those that are clearly or obviously invalid. For example, in selected embodiments, a request preprocessor 188 may screen content requests 74 to locate those having tokens lacking the appropriate number of characters, those where the application does not correspond to the content (e.g., the application is for playing music, but the requested content comprises a text document), or the like. Additionally, screening by the request preprocessor 188 may resist an overload if the authentication system 62 were “under attack” with high volumes of irrelevant content requests 74.

When a request preprocessor 188 locates a clearly invalid content request 74, the content server 68 may immediately respond 80 by denying content. If desired, this denial may be asserted without preparing and transmitting an authentication response 76 and waiting for an authentication response 78. Accordingly, in selected embodiments, a request preprocessor 188 may improve the efficiency of the authentication system 62.

In selected embodiments, a verification module 178 in accordance with the present invention may also include an authentication request module 190. An authentication request module 190 may be primarily responsible for extracting the necessary information from the content request 74, preparing an appropriate authentication request 76, transmitting the authentication request 76 to the application server 66, receiving an authentication response 78 from the application server 66, interpreting the authentication response 78, and passing the content request 74 back to the server module 176 when service of the desired content is appropriate. In selected embodiments, an authentication request module 190 may simply “sit on” or ignore content requests 74 determined by the application server 66 to be invalid.

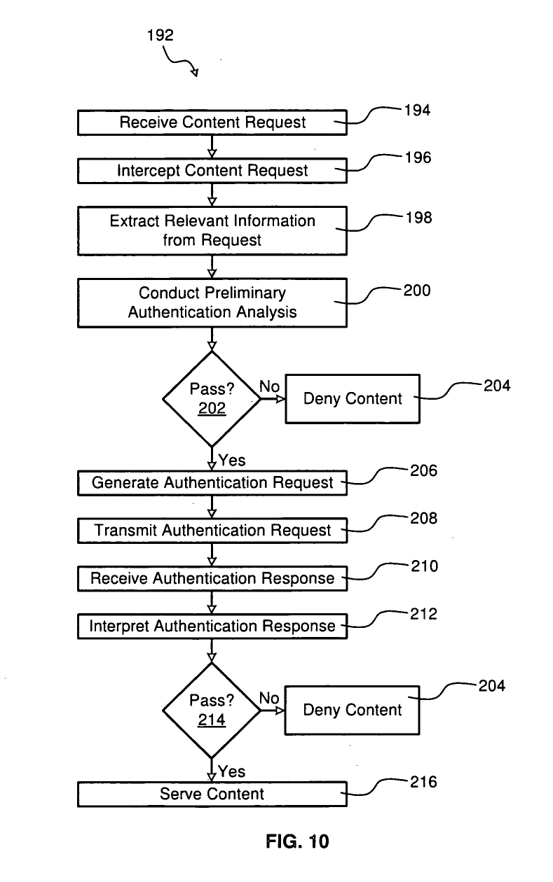

Referring to FIG. 10, the foregoing provides one or more possible embodiments, architectures, or structural arrangements for a content server 68 in accordance with the present invention. These embodiments are to be considered in all respects only as illustrative, and not restrictive.

In general, the interaction of a content server 66 with a user computer 64 and an application server 66 may be referred to as a content verification and delivery process 192. Any software, hardware, or software and hardware configuration capable of performing the content verification and delivery process 192 may be considered a content server 68 in accordance with the present invention.

In selected embodiments, a content verification and delivery process 192 may begin when a content server 68 receives 194 a content request 74. In certain embodiments, the content request 74 may be intercepted 196 before a reply serving content is generated. Relevant information may then be extracted 198 from the content request 74. A preliminary authentication analysis may be conducted 200 on selected portion of this relevant information.

This preliminary analysis may search for clear or obvious problems with the content request 74. A determination 202 may then be made as to whether the content request 74 passes a selected or preliminary threshold. If the content request 74 does not “pass,” the content indicated in the content request 74 may be denied 204. Alternatively, if the content request 74 passes, an authentication request 76 may be generated 206 and transmitted 208 to the application server 66.

In response to the authentication request 76, a content server 68 may receive 210 an authentication response 78. This response 78 may be interpreted 212 to understand the instructions contained therein. Accordingly, a determination 214 may be made as to whether the application server 66 has passed the content request 74. If the application server 66 does not pass the content request 74, the content indicated in the content request 74 may be denied 204. Alternatively, if the application server 66 passes the content request 74, the content indicated in the content request 74 may be served 216 to the user computer 64.

In certain embodiments, a content verification and delivery process 192 may proceed in an order different from that illustrated in FIG. 10. For example, in selected embodiments, the step of conducting 200 a preliminary authentication analysis may be omitted. Accordingly, in selected embodiments, the content verification and delivery process 192 may pass from extracting 198 relevant information from the content request directly to generating 206 an authentication request 76.

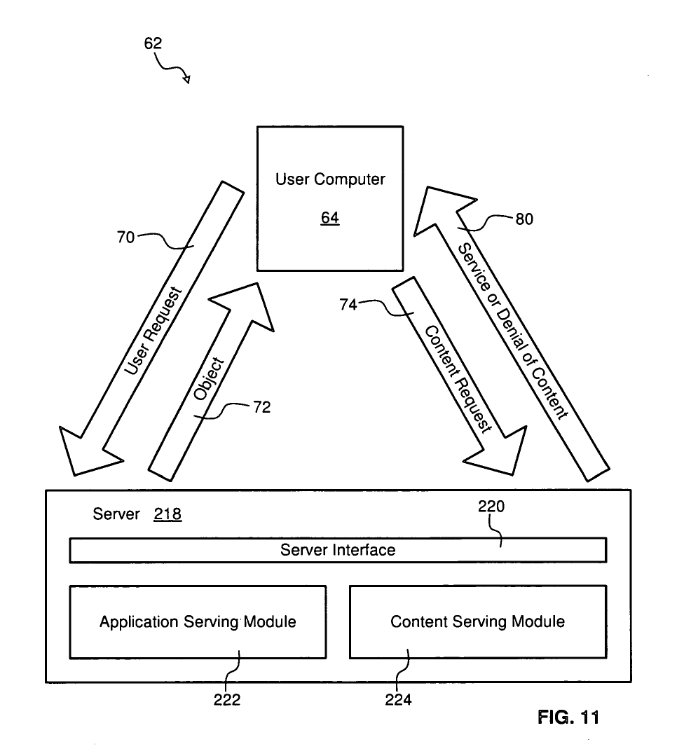

Referring to FIG. 11, an application server 66 and content server 68 may be hosted on any node 12 or combination of nodes 12 operably connected via the network 40 or neighboring network 58 to each other as well as to the user computer 64. For example, in selected embodiments, the application server 66 may correspond to one or more nodes 12 positioned remotely from the one or more nodes 12 corresponding to the content server 68. Alternatively, both the application server 66 and the content server 68 may correspond to a single node 12. In such embodiments, the configuration of the application server 66 and content server 68 may differ from configurations where the two severs 66, 68 are positioned remotely from one another.

For example, in selected embodiments, a single server 218 may perform the functions of both the application server 66 and the content server 68. In certain embodiments, such a server 218 may include a server interface 220, an application serving module 222, and a content serving module 224.

An application serving module 222 may incorporate the functions 102, 104 and structures of an application server 66. For example, in selected embodiments, an application serving module 222 may include a web server 82 and an authentication coordination module 84. Similarly, a content serving module 224 may incorporate the functions 192 and structures of a content server 68. For example, in selected embodiments, a content serving module 224 may include a server module 176, verification module 178, and content library 182.

A server interface module 220 may manage, translate, and direct communications between the user computer 64 and the application serving and content serving modules 222, 224 of the server 218. For example, the server interface 220 may identify user requests 70 and direct them to the application serving module 222. Similarly, the server interface 220 may identify content requests 74 and direct them to the content serving module 224.

In selected embodiments, the server interface 220 may also facilitate the internal communications within the server 218. For example, the server interface 220 may assist in appropriately passing authentication requests 76 and authentication responses 78 between the content serving module 224 to the application serving module 222. Alternatively, however, in certain embodiments, authentication requests 76 and authentication responses 78 may pass directly between the content serving module 224 to the application serving module 222, without the assistance of the server interface 220.

The present invention may be embodied in other specific forms without departing from its basic structure or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. A method comprising:
providing an application server and a content server operably connected to a network, the network rendering the application server and content server accessible to at least one user computer;
storing at least one resource on the content server;
operating the application server to receive a user request from the at least one user computer and respond thereto by transmitting selected data to the at least one user computer; and
operating the content server to receive from the at least one user computer a content request comprising at least some portion of the selected data, generate an authentication request comprising the at least some portion of the selected data, transmit the authentication request to the application server, and serve the at least one resource as directed by a corresponding authentication response received from the application server.

2. The method of claim 1, further comprising operating the application server to receive the authentication request from the content server, make a determination whether the at least some portion of the selected data corresponds to a valid content request, generate the authentication response in accordance with the determination, and transmit the authentication response to the content server.

3. The method of claim 2, wherein the network comprises the Internet.

4. The method of claim 3, wherein the selected data comprises an object including executables and attributes.

5. The method of claim 4, wherein the object is configured to, when executed, generate the content request and transmit the content request from the user computer to the content server.

6. The method of claim 5, wherein the executables of the object provide an application.

7. The method of claim 6, wherein the application is configured to operate on the user computer to present the at least one resource.

8. The method of claim 7, wherein the object comprises a token indicating one of the number of times the application is permitted to present the at least one resource and the period of time in which the application is permitted to present the at least one resource.

9. The method of claim 8, wherein the at least one resource comprises one of a motion picture in a digital format and a musical composition in digital format.

10. The method of claim 9, wherein the application server and content server are hosted on different computers.

11. The method of claim 1, wherein the selected data comprises an object configured to, when executed, generate the content request and transmit the content request from the user computer to the content server.

12. The method of claim 1, wherein the selected data comprises an object configured to, when executed provide an application to operate on the user computer and present the at least one resource.

13. The method of claim 12, wherein the object further comprises an object containing a token indicating one of the number of times the application is permitted to present the at least one resource and the period of time in which the application is permitted to present the at least one resource.

14. The method of claim 1, wherein the at least one resource comprises one of a motion picture in a digital format and a musical composition in digital format.

15. The method of claim 1, wherein the application server and content server are hosted on different computers.

16. A method comprising:
providing an application server and a content server operably connected to a network, the network rendering the application server and content server accessible to at least one user computer;
storing a plurality of resources on the content server;
operating the application server to receive a user request from the at least one user computer and respond thereto by transmitting selected data to the at least one user computer;
operating the content server to receive from the at least one user computer a content request comprising at least some portion of the selected data, generate an authentication request comprising the at least some portion of the selected data, and transmit the authentication request to the application server;
operating the application server to receive the authentication request from the content server, make a determination whether the at least some portion of the selected data indicates a valid content request, generate the authentication response in accordance with the determination, and transmit the authentication response to the content server; and
operating the content server to serve at least one resource of the plurality of resources to the user computer as directed by the authentication response received from the application server.

17. A system comprising:
a network
an application server connected to the network;
a content server connected to the network and storing at least one resource;
the application server configured to receive a user request and respond thereto by transmitting selected data and to receive an authentication request and respond thereto with an authentication response; and
the content server configured to receive a content request comprising at least some portion of the selected data, generate the authentication request comprising the at least some portion of the selected data, transmit the authentication request to the application server, and serve the at least one resource as directed in the authentication response.

18. The system of claim 17, further comprising a user computer connected to the network.

19. The system of claim 18, wherein the user computer generates the user request in accordance with inputs received form a user and transmits the user request to the application server.

20. The system of claim 19, wherein the user computer receives the selected data, automatically generates the content request therefrom, and transmits the content request to the content server.
